(19) United States
(12) Patent Application Publication
(10) Pub. No.: US 2020/0104770 A1
(43) Pub. Date: Apr. 2, 2020

(54) RIDESHARE WITH SPECIAL NEED ACCOMMODATIONS

(71) Applicant: Ford Global Technologies, LLC, Dearborn, MI (US)

(72) Inventors: Sudipto Aich, Palo Alto, CA (US); Jeanne Isaacs, Los Altos, CA (US); Vinita Israni, Palo Alto, CA (US)

(73) Assignee: Ford Global Technologies, LLC, Dearborn, MI (US)

(21) Appl. No.: 16/585,220

(22) Filed: Sep. 27, 2019

Related U.S. Application Data
(60) Provisional application No. 62/738,303, filed on Sep. 28, 2018.

(51) Int. Cl. G06Q 10/06; G01C 21/34; B60N 2/30; B60N 2/02; A61G 3/08; G06Q 30/02

(52) U.S. Cl. CPC G06Q 10/06311; G01C 21/3438; G01C 21/3461; G06Q 30/0284; B60N 2/30; B60N 2/0244; A61G 3/0808; G01C 21/3415

(57) ABSTRACT

A provider, such as a transportation management service, can manage transport for a number of passengers, including passengers with special needs, between various locations. Individual routes can include at least two segments using the same or different modes of transportation. A customer can select a transportation option for the journey that causes reservations to be made for the various segments. Based on the needs of a passenger, transportations options may be limited to those using vehicles that accommodate for the passenger's needs. In some cases, other passengers may be rebooked in order to accommodate a passenger's travel needs, and in some instances, a route may be modified to accommodate a passengers travel needs.

### CROSS-REFERENCE TO RELATED APPLICATION(S)

This application claims the benefit and priority of U.S. Provisional Application Ser. No. 62/738,303, titled “RIDESHARE WITH SPECIAL NEED ACCOMODATIONS”, filed on Sep. 28, 2018, which is hereby incorporated by reference herein in its entirety, including all references and appendices cited therein, for all purposes.

### FIELD OF INVENTION

The present disclosure is generally directed to systems and methods that accommodate users with special needs with respect to rideshare reservations, as well as specific vehicle configurations supporting the same.

### BACKGROUND

People are increasingly turning to a variety of different transportation and mobility offerings, including ridesharing and e-biking in addition to conventional public transit offerings such as trains and public buses. Ridesharing can involve riders being allocated vehicles that are dedicated to those riders for a period of time, or being allocated seats on vehicles that will have other passengers riding at the same time. While individually allocated cars can have some benefits, sharing vehicles can reduce costs and provide some certainty as to scheduling. Ridesharing services have historically regarded passengers on a one size fits all basis.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIGS. 1A and 1B illustrate an example ride request environment in which aspects of various embodiments can be implemented.

FIG. 2 illustrates an example approach for matching ride requests to vehicle capacity that can be utilized in accordance with various embodiments.

FIGS. 3A and 3B illustrate example origination and destination locations, and routes for serving those locations, that can be determined for a service area over a period of time in accordance with various embodiments.

FIG. 4 illustrates an example system that can be utilized to implement aspect of the various embodiments.

FIG. 5 illustrates an example process for determining routing options for a plurality of ride or transport requests that can be utilized in accordance with various embodiments.

FIG. 6 illustrates an interface through which a customer can provide information related to special needs and/or services that may be needed

FIG. 7 illustrates a vehicle configuration for accommodating the special needs of certain customers.

FIG. 8 illustrates an example method that can be used for routing customers with travel parameters that include a needed vehicle configuration.

FIG. 9 illustrates an example method that can be used for routing different passenger types.

### DETAILED DESCRIPTION

### Overview

Approaches described and suggested herein relate to the providing of transportation between specified locations. In particular, systems and methods disclosed herein provide approaches for providing special accommodations and/or services that may be specified by some passengers. These passengers may be classified by a set of transportation specifications or parameters which may accompany a travel request. When determining routing solutions for these customers, a set of rules corresponding to the travel parameters can be used. Providing accommodations to some passengers may indicate a vehicle to be reconfigured or have a route in some way altered. In some cases, other passengers may need to be re-routed in order to provide accommodations.

Transportation requests can relate to the transportation of people, animals, packages, or other objects or passengers, from an origination location to a destination location. The requests may also include at least one time component, such as a requested time of departure or arrival. A provider, such as a transportation service, can utilize a routing determination process, for example, to balance various metrics when selecting between proposed routing solutions to serve a set of customer trip requests. One or more optimization processes can be applied, which can vary the component values or weightings of the routing process in order to attempt to improve the options generated and/or selected for each proposed routing solution. A solution can be selected for implementation based at least in part upon the resulting quality scores of the proposed routing solutions.

The routes selected between a point of origin and a destination can include at least two legs or segments, which can be provided by the same or different modes of transportation. A customer can submit a request for transportation between an origin and a destination at, or near, a specified time, and can receive information for traveling options along one or more routes between those locations. A customer can select one or more options for the journey. The transportation for the selected option(s) can then be booked, such that sufficient capacity is reserved for the rider.

### Illustrative Embodiments

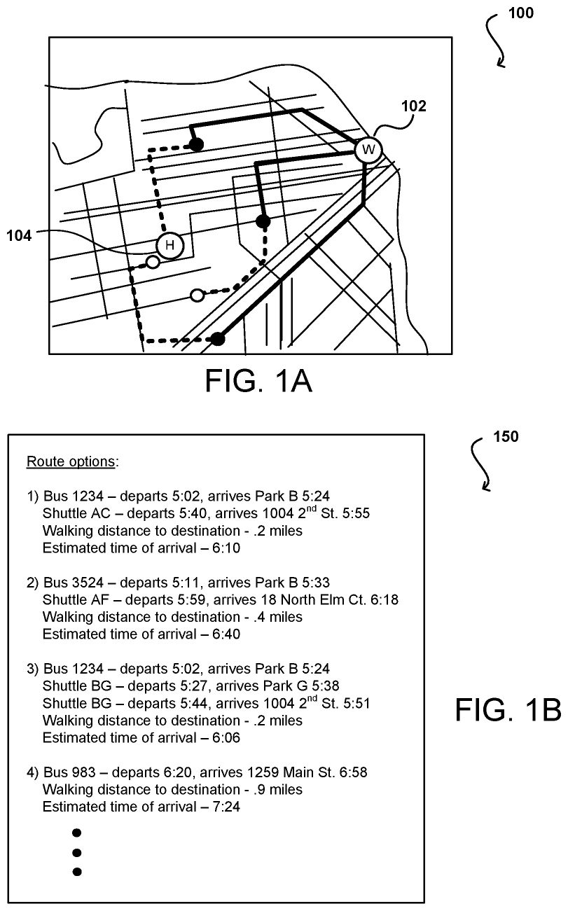

FIG. 1A illustrates an example location 100 in which aspects of the various embodiments can be implemented. In this example, a user can request transportation from an origin 102 to a destination location 104 using, for example, an application executing on a client computing device. Various other approaches for submitting requests, such as by messaging or telephonic mechanisms, can be used as well. Further, at least some of the requests can be received from, or on behalf of, an object being transported or scheduled to be transported. For example, a client device might be used to submit an initial request for an object, package, or other deliverable, and then subsequent requests might be received from the object, for example, or a device or mechanism associated with the device. Other communications can be used in place of requests, as may relate to instructions, calls, commands, and other data transmissions. A “client device” should not narrowly be construed as a conventional computing device unless otherwise stated, and any device or component capable of receiving, transmitting, or processing data and communications can function as a client device.

The transportation can be provided using one or more vehicles (or other modes of transportation) capable of concurrently transporting one or more riders. While riders as used herein will often refer to human passengers, it should be understood that a “rider” can also refer to a non-human rider or passenger, as may include an animal or an inanimate object, such as a package for delivery. The rides provided to an individual rider from the point of departure to the point of arrival may also involve one or more vehicles, which may be of the same or different types, for the same or different modes of transportation. For example, in FIG. 1A a customer of a transportation service might want to use the service to obtain transport from a specified origin 102 or point of departure, such as the customer's place of employment, to a specified destination 104 or point of arrival, such as the user's home. Various other types of locations or ways of specifying locations can be used as well. There may be modes of transportation offered that use fixed routes (such as trains or public buses), semi-fixed routes (such as shuttle buses), flexible routes (such as rideshares in passenger vehicles), or complete flexibility (such as e-bikes or scooters), among other such options. While more flexible options, such as ride shares, may provide for the shortest travel times in some situations, they may also come at a higher cost than fixed route options, such as subways or public buses. Further, flexible route options such as rideshares may be subject to traffic congestion or other issues that may introduce additional uncertainty into arrival times, and so forth.

For at least some of these reasons, customers or riders may choose to take fixed route transportation for at least some of their journey. For example, a customer might take a public bus out of downtown due to the relatively low cost and frequent availability of the buses. These buses can go to one or more stops from which the customer can obtain a connecting transport if needed, or desired, to complete a remainder of the journey. In many instances, a customer might want flexibility in the timing of the bus or initial mode of transport, such as to be able to catch the next available bus along a given route. A customer might also want to be able to select from multiple available routes to obtain additional options. As illustrated in FIG. 1A, there may be a number of bus routes (illustrated using the solid lines) that go from a destination, such as a bus stop near the customer's place of employment, to one or more destinations along substantially fixed routes. The customer may be willing to take any of these routes from the point of origin 102, particularly at rush hour or in inclement weather, just as an example.

A customer can view potential options for routes that involve multiple legs or segments, which may utilize one or more types of transportation. The customer can then select the option that is most desirable or of interest to them, or at least most closely satisfies the customer's current selection criteria, as may include timing and price, among other such options. An example presentation 150 of a set of options is illustrated in FIG. 1B. In this example, the customer is able to view a number of different options that satisfy, or otherwise at least partially match, one or more search criteria submitted by the customer for a future transportation need. The options can include different times of departure near the customer's requested time, that all leave from a specified location. The options include different options for the initial leg, here including different buses that travel at different times and/or to different locations. From those locations, there are different options presented to continue on towards the destination. These include not only different connection options, such as different shuttles, but also include options for walking or biking certain distances, and so forth. A user can select from among these options, and a transportation service or other entity system providing the options can cause corresponding reservations to be made for the selected options, such as for capacity on specific vehicles or routes as made through the corresponding transportation providers, which may include public entities or other third parties.

A rider may begin a journey by boarding a vehicle or transport for the first segment of the journey. This can include, for example, boarding a bus or train that is leaving from, or near, the origin point of the journey. As discussed elsewhere herein, the rider might confirm that the rider has boarded a particular vehicle in a number of different ways, such as through manual input into a transportation app, through tapping a sensor or scanning a code upon entering the vehicle, or through the providing of geo-location data through a rider's portable computing device, among other such options. A transport provider system can then monitor or track information about the current segment in progress to update estimates for the time of arrival of the vehicle at a specified location. If a passenger is delayed and will not be able to make the next leg of their route, then re-routing options may be presented to a user which may determine that the user to take a different vehicle than initially planned for one or more legs of a trip itinerary. If a special needs passenger is re-routed, the passenger may be provided with alternate routes which can accommodate their needs. When a passenger is re-routed to a different vehicle, the seating arrangement of the vehicle may need to be reconfigured prior to loading the passenger. For example, a re-routed passenger uses a wheelchair, one or more seats may need to be removed or lowered into the floor of the vehicle so that the passenger can be accommodated. In this instance, the reconfiguration can occur in some cases as soon as when the re-booking of the passenger is confirmed.

A customer can provide permissions that enable aspects of a reservation to be booked, updated, or rebooked automatically as appropriate, or at least under permitted condition. For example, if a passenger's route is adjusted so that another passengers with special travel parameter can be accommodated by the rideshare service, then route may be rebooked automatically. The permission may also allow for only certain types of rebooking, such as rebooking of future segments of a current journey that are selected to complete the journey. A transportation service may receive permission to rebook any time the new option is better than a currently reserved option, potentially by at least a determined or threshold account, based on current or anticipated conditions. This can be due to a new seat coming available, a rider being ahead of schedule, the changing of one or more routes to accommodate a special needs passenger, or a vehicle for a segment being behind schedule, among other such options. The rebooking of a specified segment can also trigger the rebooking of other segments of a multi-segment journey as appropriate, or as improved alternatives are discovered. A customer might select an option in a transportation app to check whether a better option has become available, or to adjust criteria in order to attempt to find an alternate route, and so forth.

A specific type of action might trigger an automatic rebooking on behalf of a rider or customer. For example, a rider might board a different vehicle or route than was reserved or intended. Accordingly, the transportation service, upon learning of such information, can attempt to determine options that will enable the rider to arrive at, or near, their destination based on the current vehicle or route.

There may also be additional or alternative criteria used for the rebooking of segments of a journey. For example, some customers might have more specific criteria for rebooking due to service provider error, or other non-rider error, to make up for the inconvenience. Similarly, other customers might have more relaxed criteria, as the customer may just want the rider to get to the destination in the best way possible after a delay, error, or incident. IA customer might only enable a rebooking if the connection time will be less than one minute, while others might enable rebooking if the connection time will be less than five minutes or may indicate more than a specified amount of walking, among other such options. Customers may also have preferences for certain types of vehicles for the initial journey booking, or may prefer not to go through certain areas or routes, but may not be as picky if the preference will result in a significant delay under current conditions. At least some of these preferences can be learned through machine learning by analyzing customer ride data and other such information.

A determination of a rider's estimated time of arrival may be based primarily on relative position. For example, a region might be mapped out onto a grid, and there may be mappings of travel times between pairs of the grids. Thus, if a vehicle along a current route is not in a block of the grid that has a travel time less than a time remaining to a connection, then the system can determine that rebooking is appropriate. The travel times can also have a margin of error or certainty that can be factored into the determination as well. Various other mechanisms for determining time of arrival and connection time can be used as well as discussed and suggested elsewhere herein.

The transportation service might also generate a new set of routes or segment options for certain circumstances. For example, there might be an accident or event that will cause a large number of riders to miss their planned connections. Instead of booking all these riders on later options, the transportation service might decide to alter the available routes to enable more riders to get to their destinations in a timelier manner. This will still effectively be a rebooking of the segment, but can correspond to a new route option that was not available previously. In another example, as discussed in greater detail elsewhere herein, a new route may be generated in order to pick up or drop off a passenger who is unable to navigate to a standard loading or unloading location. Connection times for the relevant modes of transportation are much shorter than for other modes of transportation, such as airlines, such that a continual and more granular analysis can be used advantageously. Further, there can be many more options, some of which can utilize flexible routing, which generally are not available to airlines or other such modes of transportation. The routes might not be changed, but the individual segments might be changed. For example, a bus might make four stops before arriving at a designated connection point. The transportation service might decide that a better option for a rider would leave from the second stop, and thus might alter the current segment to terminate for connection at the second stop. The length of the segment could alternatively be increased for similar reasons.

A transportation system can provide for the automated booking and/or selection of travel options for a customer, such as is also referred to a rider elsewhere herein. The customer can provide information about a desired journey, such as timing information in addition to information about the origin and destination locations for the journey.

As mentioned, the types of transportation booked can vary depending upon factors such as availability, route determination criteria, customer travel parameters, and customer preference, among other such options. For example, some customers may be willing (or prefer) to take an electronic bike or electronic scooter for at least a portion of the journey, while other customers may only be willing to ride in enclosed vehicles such as cars, buses, or trains. The preferences may vary based on environmental factors, such as rain or the traffic at a particular time of day. A customer can provide their preference information, or the customer preferences can be learned over time, such as by processing customer selection, behavior, and/or review data using machine learning or another such process. This information can then be factored into the route determination and/or optimization algorithms as discussed in more detail elsewhere herein.

As mentioned, certain customers may not want to be automatically booked, or rebooked, for any or all legs of a journey, and may instead allow for prior approval. In such cases, one or more recommendations for a connection can be surfaced to the user, which the user can approve or decline, and can have the ability to select a new option or enter new or additional criteria for a remainder of the route. In such cases, the customer might see the connection information sooner in the process, such as at a time of starting the journey or boarding the initial vehicle, in order to ensure that the customer receives and approves the connection information. A notification can be sent to the customer that can cause a customer device to ring, vibrate, or otherwise indicate to the user that a message or notification has been received that requests the customer to view and approve. A default booking might be made for the customer in case the customer does not respond or confirm in time, such that the customer will at least be able to have an option to finish the ride. The bookings will be held until confirmation time to ensure availability, although other confirmed bookings may take precedence over pending bookings, and so forth.

As with single ride preferences, there can be customer preferences determined for selecting transportation for journeys requiring multiple segments. For example, a customer might prefer the shortest overall time duration regardless of the number of connections or modes of operation used. Others might prefer comfort, shortest connection times, or minimum number of connections, among others. For some customer, the preferences may vary by direction. For example, a customer might want to take only enclosed vehicles on the way to work, but may be more willing to walk or bike on the way home. Certain customers may also have preferred stop locations, or can specify locations or modes of transportation that are not to be used. A customer can also specify specific segments, vehicles, routes, or other aspects that are preferred, or not to be selected, and so forth. Various other options can be specified, such as maximum use of highway versus neighborhood driving, minimum or maximum pricing, minimum or maximum quality of service, and so forth. Any or all of these and other factors or preferences can be used with a routing selection and/or optimization function or process as discussed and suggested herein. Further, as mentioned at least some of these preferences can be learned for a customer over time.

An entire journey can be automatically booked or suggested to a customer. For example, a customer might leave from work at the same time on most weekdays. Accordingly, the service could send a notification to the customer as discussed above, but this notification instead could ask the user to confirm booking on the initial segment of the journey. This might be the same transportation option that the customer usually takes, or can be one of the options that are appropriate for the time and location. The user can confirm, select an option, decline, or specify new criteria for this particular time, such as an updated departure time or location. Various other options can be used as well. In such a situation, the customer might have to confirm the selections for the subsequent segments of the journey, or the initial confirmation may enable the system to automatically book transport for each segment at a time appropriate based on any factors, or combinations thereof, discussed herein.

The automatic booking may specify the customer to take different actions as well. For example, the customer might be on a train or bus that makes multiple stops. The transportation options for the next segment may depart from different stops or stations, such that the customer may need to be notified of the appropriate stop at which to catch the connection. If this is to be different from the typical or standard stop for that customer, or is anything other than the last stop, then the customer may need to confirm that the customer has received the instruction and will get off at the appropriate stop. The next segment can be automatically confirmed in response to the customer getting off at that stop, which can be detected by sensor, location, or other approaches such as those discussed and suggested herein. Similarly, the customer can be notified if a better option may indicate the customer to stay on the current mode of transportation longer and instead get off at a later stop, and so forth. An application can also have an option where the user can indicate that the user would like to get off at a different stop, get to the destination sooner, or otherwise modify one or more segments. The service can then take this information and determine the best booking option based on the current location and desire of the customer.

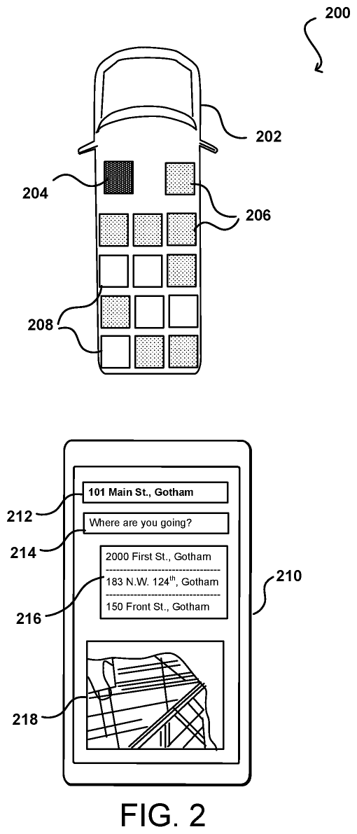

Various systems and services can be used to implement aspects of the invention as discussed and suggested herein. A transport service that provides vehicles that can concurrently be used by more than one rider is often referred to as a “rideshare” service, although as discussed vehicles such as bikes and scooters can be utilized as well which may only serve one customer at a time. In one example, a rideshare service can offer routes using at least one type of vehicle 202 that includes space 204 for a driver and seats or other capacity for up to a maximum number of riders, as illustrated in the example configuration 200 of FIG. 2. It should be understood that various types of vehicles can be used with different numbers or configurations of capacity, and that autonomous vehicles without dedicated drivers can be utilized as well. Vehicles such as smart bicycles or personal transport vehicles may be used as well, which may include seating capacity for only a single rider or limited number of passengers. For a given vehicle on a given route, a number of available seats 206 (or other rider locations) may be occupied by riders, while another number of seats 208 may be unoccupied. Objects such as packages or deliveries may also occupy available space for a ride as well, which can include areas for seating or cargo, or convertible space, among other such options. In order to improve the economics of the rides offered, it can be desirable to have the occupancy as close to full as possible during the entire length of the trip. Such a situation results in very few unsold seats, which improves operational efficiency. One way to achieve high occupancy might be to offer only fixed routes where all passengers board at a fixed origination location and off-board at a fixed destination location, with no passengers onboarding or off-boarding at intermediate locations.

A user can request transportation from an origination to a destination location using, for example, an application executing on a client computing device 210. Various other approaches for submitting requests, such as by messaging or telephonic mechanisms, can be used as well. Further, at least some of the requests can be received from, or on behalf of, an object being transported or scheduled to be transported. For example, a client device might be used to submit an initial request for an object, package, or other deliverable, and then subsequent requests might be received from the object, for example, or a device or mechanism associated with the device. Other communications can be used in place of requests, as may relate to instructions, calls, commands, and other data transmissions. A “client device” should not narrowly be construed as a conventional computing device unless otherwise stated, and any device or component capable of receiving, transmitting, or processing data and communications can function as a client device.

The transportation can be provided using a vehicle 202 (or other object) capable of concurrently transporting one or more riders. While riders as used herein will often refer to human passengers, it should be understood that a “rider” can also refer to a non-human rider or passenger, as may include an animal or an inanimate object, such as a package for delivery. In this example, a rideshare service offers routes using at least one type of vehicle that includes space 204 for a driver and seats or other capacity for up to a maximum number of riders. It should be understood that various types of vehicles can be used with different numbers or configurations of capacity, and that autonomous vehicles without dedicated drivers can be utilized as well. In order to improve or maximize the economics of the rides offered, it can be desirable to have the occupancy or utilization as close to full as possible during the entire length of the trip. Such a situation results in very few unsold seats, or little unsold capacity, which improves operational efficiency. One way to achieve high occupancy might be to offer only fixed routes where all passengers board at a fixed origination location and off-board at a fixed destination location, with no passengers onboarding or off-boarding at intermediate locations. As mentioned, such an approach may be beneficial for at least one segment of a given customer journey.

In the present example, a given user can enter an origination location 212 and a destination location 214, either manually or from a set of suggested locations 216, among other such options, such as by selecting from a map 218 or other interface element. A source such as a machine learning algorithm (or trained neural network) or artificial intelligence system can select the appropriate locations based on relevant information, such as historical user activity, current location, and the like. Such a system can be trained using historical ride data, and can learn and improve over time using more recent ride and rider data, among other such options. A backend system, or other provider service, can take this information and attempt to match the request with a specific vehicle having capacity at the appropriate time. As known for such purposes, it can be desirable to select a vehicle that will be near the origination location at that time in order to minimize overhead such as fuel and driver costs. As mentioned, the capacity can include a seat for a human rider or sufficient available volume for a package or object to be transported, among other such measures of capacity.

Such an approach may not be optimal for all situations, however, as it may be difficult to get enough users or object providers to agree to be at a specific origination location at a specific time, or within a particular time window, which can lead to relatively low occupancy or capacity utilization, and thus low operational efficiency. Further, such an approach may result in fewer rides being provided, which may reduce overall revenue. Further, requiring multiple users to travel to a specific, fixed origination location may cause those users to utilize other means of transportation, as may involve taxis or dedicated rideshare vehicles that do not specify the additional effort. Accordingly, it can be desirable to factor rider convenience into the selection of routes to be provided. What may be convenient for one rider, however, may not be convenient for other riders. For example, picking up one rider in front of his or her house might add an additional stop, and additional route distance, to an existing route that might not be acceptable to the riders already on, or assigned to, that route. Further, different riders may prefer to leave at different times from different locations, as well as to get to their destinations within a maximum allowable amount of time, such that the interests of the various riders are at least somewhat competing, against each other and those of the ride provider. It therefore can be desirable to balance the relative experience of the various riders with the economics of the rideshare service for specific rides, routes, or other transportation options. While such an approach will likely prevent a ride provider from maximizing profit per ride, there can be some middle ground that enables the service to be profitable while providing (at a minimum) satisfactory service to the various riders or users of the service. Such an approach can improve the rider experience and result in higher ridership levels, which can increase revenue and profit if managed appropriately.

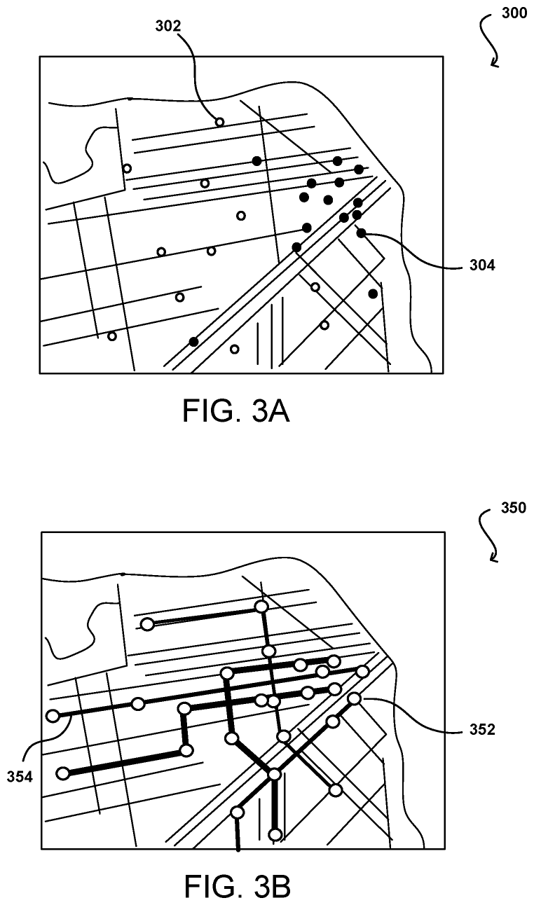

FIGS. 3A and 3B illustrate one example approach that can be utilized to provide such service in accordance with various embodiments. In the example mapping 300 of FIG. 3A, a set of origination points 302 and destination points 304 indicate locations, over a determined period of time, between which one or more users would like to travel. As illustrated, there are clusters of locations where users may want to be delivered, or objects are to be delivered, as may correspond to town centers, urban locations, or other regions where a number of different businesses or other destinations are located. The origin locations, however, may be less clustered, such as may relate to suburbs or rural areas where rider homes may be located. The clustering can also vary throughout the day, such as where people travel from their homes to their places of employment in the mornings, and generally travel in the reverse directions in the evening. There may be little clustering between these periods, or the clustering may be primarily to locations within an urban area. Economically, it may not be practical for a multi-rider vehicle service to provide each person a dedicated vehicle for the determined route, as the overall occupancy per vehicle would be very low. Ensuring full occupancy for each vehicle, however, can negatively impact the experience of the individual riders who may then have to have longer routes and travel times in order to accommodate the additional riders, which may cause them to select other means of transportation. Similarly, requiring a large number of passengers to meet at the same origination location may be inconvenient for at least some of those passengers, who may then choose alternate travel options.

It can be desirable to provide routes and transportation options that balance, or at least take into consideration, these and other such factors. As an example, the mapping 350 of FIG. 3B illustrates a selection of routes 352 that can be provided over a period of time in order to satisfy various rider requests. The routes may not include or correspond to each precise origination and destination location, but can come within an acceptable distance of those locations in most instances. Each route can also be served by one or more vehicles or modes of transportation, each servicing a portion or segment of a given route. There may be situations where origination or destination locations are not served, or served at particular times, where route options may not be available, although a dedicated, limited capacity vehicle may be offered at a determined price, among other such options. Further, while the routes may not enable every vehicle to have full occupancy, the number of passengers per vehicle can be sufficient to provide at least adequate profitability or efficiency to the ridesharing service. The routes 352 provided by such a service may change over time, or even at different times of day, but can have at least a subset of segments that are sufficiently set such that riders can have at least some level of certainty over their commute or travel. While this may not offer the flexibility of other travel options, it can provide certainty of travel at a potentially lower cost point, which can be desirable to many potential users of the service. As mentioned, however, such a service can also provide added flexibility with other ride options, which may come with a higher price to the potential rider.

In order to determine the routes to provide, as well as the vehicles (or types of vehicles) to use to provide those routes, various factors can be considered as discussed and suggested herein. A function of these factors can then be optimized in order to provide for an improved customer experience, or transport experience for transported objects, while also providing for improved profitability, or at least operational efficiency, with respect to other available routing options. The optimization approaches and route offerings can be updated over time based on other available data, as may relate to more recent ride data, ridership requests, traffic patterns, construction updates, and the like. An artificial intelligence-based approach, as may include machine learning or a trained neural network, for example, can be used to further optimize the function based upon various trends and relationships determined from the data as discussed elsewhere herein.

At least one objective function can be utilized to determine route options for a set of vehicles, or other transportation mechanisms, for one or more regions of service or coverage. At least one optimization algorithm can be applied to adjust the various factors considered in order to improve a result of the objective function, such as to minimize or maximize the score for a set of route options. The optimization can apply not only to particular routes and vehicles, for example, but also to future planned routes, individual riders or packages, and other such factors. An objective function can serve as an overall measure of quality of a routing solution, set of proposed routing options, or past routing selections. An objective function serves as a codification of a desire to balance various factors of importance, as may include the rider's convenience or experience, as well as the service delivery efficiency for a given area and the quality of service (QoS) compliance for specific trips, among other such options. For a number of given origination and destination locations over a given period of time, the objective function can be applied and each proposed routing solution given a score, such as an optimized route score, which can be used to select the optimal routing solution. The routing option with the highest route score will be selected. Alternatively, there can be approaches to maximize or minimize the resulting score, or generate a ranking, among various other scoring, ranking, or selection criteria. Routing options with the lowest score may be selected as well, such as where the optimization function may be optimized based on a measure of cost, which may be desirable to be as low as possible, versus a factor such as a measure of benefit, which may be desirable to be as high as possible, among other such options. The option selected may not have the optimal objective score, but has an acceptable objective score while satisfying one or more other ride selection criteria, such as may relate to operational efficiency or minimum rider experience, among others. An objective function accepts as inputs the rider's convenience, the ability to deliver confirmed trips, the fleet operational efficiency, and the current demand. There may be weightings of each of these terms that may be learned over time, such as through machine learning. The factors or data making up each of these terms or value can also change or be updated over time.

Component metrics, such as the rider's convenience, QoS compliance, and service delivery efficiency can serve at least two purposes. For example, the metrics can help to determine key performance indicator (KPI) values useful for planning service areas and measuring their operational performance. Performance metrics such as KPIs can help to evaluate the success of various activities, where the relevant KPIs might be selected based upon various goals or targets of the particular organization. Various other types of metrics can be used as well. For instance, locations for which to select service deployment can be considered, such as where a service area (e.g., a city) can be selected, and it may be desired to develop or apply a deployment or selection approach that is determined to be optimal, or at least customized for, the particular service area. Further, these metrics can help to provide real-time optimization goals for the routing system, which can be used to propose or select routes for the various requests. The optimization may indicate the metrics to be calculated for partial data sets for currently active service windows, which may correspond to a fixed or variable period of time.

As an example, a rider's convenience score can take into account various factors. One factor can be the distance from the rider's requested origination point to the origination point of the selected route. The scoring may be performed using any relevant approach, such as where an exact match is a score of 1.0 and any distance greater than a maximum or specified distance achieves a score of 0.0. The maximum distance may correspond to the maximum distance that a user is willing to walk or travel to an origination location, or the average maximum distance of all users, among other such options. For packages, this may include the distance that a provider is willing to travel to have those packages transported to their respective destinations. The function between these factors can vary as well, such as may utilize a linear or exponential function. For instance, an origination location halfway between the requested and proposed origination locations might be assigned a convenience score of 0.5, while in other approaches is might earn 0.3 or less. A similar approach may be taken for time, where the length of time between the requested and proposed pickups can be inversely proportional to the convenience score applied. Various other factors may be taken into account as well, as may include ride length, number of stops, destination time, anticipated traffic, and other such factors. The convenience value itself may be a weighted combination of these and other such factors.

Optimizing, or at least taking into consideration, a rider's convenience metric can help to ensure that trips offered to the riders are at least competitively convenient. While rider convenience may be subjective, the metric can look at objective metrics to determine whether the convenience is competitive with respect to other means of transportation available. Any appropriate factors can be considered that can be objectively determined or calculated using available data. These factors can include, for example, an ability (or inability) to provide various trip options. The factors can also include a difference in the departure or arrival time with respect to the time(s) requested by the riders for the route. A rider can provide a target time, while in others the riders can provide time windows or acceptable ranges, among other such options. Another factor can relate to the relative trip delay, either as expected or based upon historical data for similar routes. For example certain routes through certain high traffic locations may have variable arrival times, which can be factored into the convenience score for a potential route through that area or those locations. Another factor may relate to the walking (or non-route travel) ability of the user for a given route. This can include, as mentioned, the distance between the requested origin and the proposed origin, as well as the distance between the requested destination and the proposed destination. Any walking specified in the transfer vehicles may also be considered if appropriate.

Various other factors can be considered as well, where the impact on convenience may be difficult to determine but the metrics themselves are relatively straightforward to determine. For example, the currently planned seating or object capacity utilization can be considered. While it can be desirable to have full occupancy or capacity utilization from a provider standpoint, riders might be more comfortable if they have some ability to spread out, or if not every seat in the vehicle is occupied. Similarly, while such an approach may not affect the overall ride length, any backtracking or additional stops at a prior location along the route may be frustrating for various riders, such that these factors may be considered in the rider's convenience, as well as the total number of stops and other such factors. The deviation of a path can also be factored in, as sometimes there may be benefits to taking a specific path around a location for traffic, toll, or other purposes, but this may also be somewhat frustrating to a user in certain circumstances.

Another factor that may be considered with the rider convenience metric, but that may be more difficult to measure, is the desirability of a particular location. The score may be determined by an employee of the provider. A score may be determined based on reviews or feedback of the various riders, among other such options. Various factors can be considered when evaluating the desirability of a location, as may relate to the type of terrain or traffic associated with a spot. For example, a flat location may get a higher score than a location on a steep hill. Further, the availability, proximity, and type of smart infrastructure can impact the score as well, as locations proximate or managed by smart infrastructure may be scored higher than areas locations without such proximity, as these areas can provide for more efficient and environmentally friendly transport options, among other such advantages. Similarly, a location with little foot traffic might get a higher score than near a busy intersection or street car tracks. A safety metric may be considered, as may be determined based upon data such as crime statistics, visibility, lighting, and customer reviews, among other such options. Various other factors may be considered as well, as may relate to proximity of train lines, retail shops, coffee shops, and the like. A weighted function of these and other factors can be used to determine a rider's convenience score for a proposed route option.

Another component metric that can be utilized relates to the quality of service (QoS) compliance. As mentioned, a QoS compliance or similar metric can be used to ensure that convenience remains uncompromised throughout the delivery of a route. There may be various QoS parameters that apply to a given route, and any deviation from those parameters can negatively impact the quality of service determined for the route. Some factors may be binary in their impact, such as the cancelation of a trip by the system. A trip is either canceled or performed, at least in part, which can indicate compliance with QoS terms. Modification of a route can also impact the QoS compliance score if other aspects of the trip are impacted, such as the arrival time or length of travel. Other factors to be considered are whether the arrival time exceeded the latest committed arrival time, and by how much. Further, factors can relate to whether origination or destination locations were reassigned, as well as whether riders had to wait for an excessive period of time at any of the stops. Reassignment of vehicles, overcapacity, vehicle performance issues, and other factors may also be considered when determining the QoS compliance score. The historical performance of a route based on these factors can be considered when selecting proposed routes as discussed herein.

With respect to service delivery efficiency, the efficiency can be determined for a specific service area (or set of service areas). Such a factor can help to ensure that fleet operations are efficient, at least from a cost or resource standpoint, and can be used to propose or generate different solutions for various principal operational models. The efficiency can be determined based on a combination of vehicle assignment factors, as may related to static and dynamic assignments. For a static vehicle assignment, vehicles can be committed to a service area for the entire duration of a service window, with labor cost being assumed to be fixed. For dynamic vehicle assignment, vehicles can be brought in and out of service as needed. This can provide for higher utilization of vehicles in service, but can result in a variable labor cost. Such an approach can, however, minimize driving distance and time in service, which can reduce fuel and maintenance costs, as well as wear on the vehicles. Such an approach can also potentially increase complexity in managing vehicles, drivers, and other such resources needed to deliver the service.

Various factors can be considered with respect to a service efficiency (or equivalent) metric. These can include, for example, rider miles (or other distance) planned by not yet driven, which can be compared with vehicle miles planned but not yet driven. The comparison can provide a measure of seating density. The vehicle miles can also be compared with a measure of “optimal” rider miles, which can be prorated based upon anticipated capacity and other such values. The comparison between vehicle miles and optimal rider miles can provide a measure of routing efficiency. For example, vehicles not only travel along the passenger routes, but also have to travel to the origination location and from the destination location, as well as potentially to and from a parking location and other such locations as part of the service. The miles traveled by a vehicle in excess of the optimal rider miles can provide a measure of inefficiency. Comparing the optimal rider miles to a metric such as vehicle hours, which are planned but not yet drive, can provide a measure of service efficiency. As opposed to simply distance, the service efficiency metric takes into account driver time (and thus salary, as well as time in traffic and other such factors, which reduce overall efficiency. Thus, the efficiency metrics can include factors such as the time needed to prepare for a ride, including getting the vehicle ready (cleaning, placing water bottles or magazines, filling with gas) as well as driving to the origination location and waiting for the passengers to board. Similarly, the metric can take into account the time needed to finish the ride, such as to drive to a parking location and park the vehicle, clean and check the vehicle, and so forth. The efficiency can also potentially take into account other maintenance related factors for the vehicle, such as a daily or weekly washing, interior cleaning, maintenance checks, and the like. The vehicle hours can also be compared against the number of riders, which can be prorated to the planned number of riders over a period of time for a specific service area. This comparison can provide a measure of fleet utilization, as the number of available seats for the vehicle hours can be compared against the number of riders to determine occupancy and other such metrics. These and other values can then be combined into an overall service efficiency metric, using weightings and functions for combining these factors, which can be used to score or rank various options provided using other metrics, such as the convenience or QoS metrics.

Certain metrics, such as optimal rider miles and optimal distance, can be problematic to use as a measure of efficiency in some situations. For example, relying on the planned or actual distance of trips as a quantization of the quality of service provided can potentially result in degradation in the rider experience. This can result from the fact that requiring the average rider to travel greater distances may result in better vehicle utilization, but can be less optimal for users that shorter trips. Optimization of distance metrics may then have the negative impact of offsetting any gains in service quality metrics. Accordingly, approaches can utilize a metric invariant of the behavior of the routing system. The ideal mileage for a requested trip can be computed. This can assume driving a specific type of vehicle from the origin to the destination without any additional stops or deviations. The “optimal” route can then be determined based at least in part upon the predicted traffic or delays at the requested time of the trip for the ideal route. This can then be advantageously used as a measure of the service that is provided.

An example route determination system can consider trips that are already planned or being planned, as well as trips that are currently in progress. The system can also rely on routes and trips that occurred in the past, for purposes of determining the impact of various options. For trips that are in progress, information such as the remaining duration and distance can be utilized. Using information for planned routes enables the routing system to focus on a part of the service window that can still be impacted, typically going forward in time. For prorated and planned but not yet driven routes, the optimal distance may be difficult to assess directly since the route is not actually being driven. To approximate the optimal distance not yet driven, the routing system can prorate the total optimal distance to represent a portion of the planned distance not yet driven.

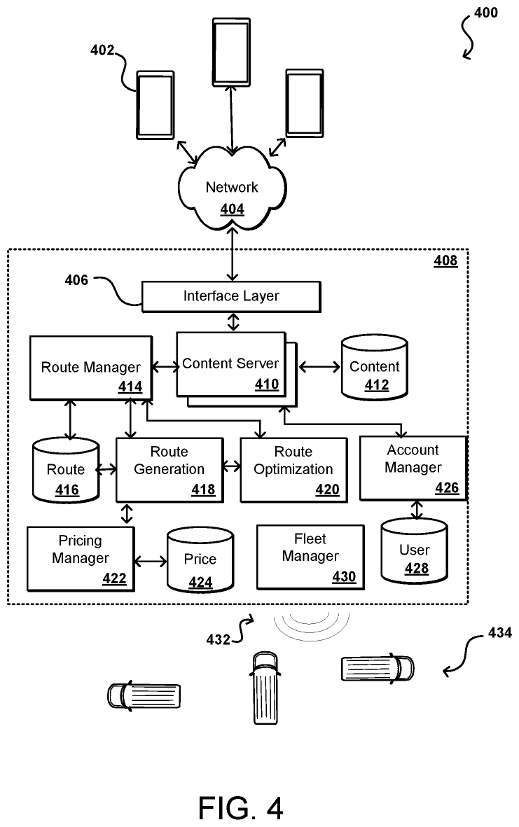

As mentioned, a route optimization system can attempt to utilize such an objective function in order to determine and compare various routing options. FIG. 4 illustrates an example system 400 that can be utilized to determine and manage vehicle routing. In this system, various users can use applications executing on various types of computing devices 402 to submit route requests over at least one network 404 to be received by an interface layer 406 of a service provider environment 408. The computing devices can be any appropriate devices known or used for submitting electronic requests, as may include desktop computers, notebook computers, smartphones, tablet computers, and wearable computers, among other such options. The network(s) can include any appropriate network for transmitting the request, as may include any selection or combination of public and private networks using wired or wireless connections, such as the Internet, a cellular data connection, a Wi-Fi connection, a local area network connection (LAN), and the like. The service provider environment can include any resources known or used for receiving and processing electronic requests, as may include various computer servers, data servers, and network infrastructure as discussed elsewhere herein. The interface layer can include interfaces (such as application programming interfaces), routers, load balancers, and other components useful for receiving and routing requests or other communications received to the service provider environment. The interfaces, and content to be displayed through those interfaces, can be provided using one or more content servers capable of serving content (such as web pages or map tiles) stored in a content repository 412 or other such location.

Information for the request can be directed to a route manager 414, such as may include code executing on one or more computing resources, configured to manage aspects of routes to be provided using various vehicles of a vehicle pool or fleet associated with the transport service. The route manager can analyze information for the request, determine available planned routes from a route data store 416 that have capacity can match the criteria of the request, and can provide one or more options back to the corresponding device 402 for selection by the potential rider. The appropriate routes to suggest can be based upon various factors, such as proximity to the origination and destination locations of the request, availability within a determined time window, and the like. An application on a client device 402 may instead present the available options from which a user can select, and the request can instead involve obtaining a seat for a specific planned route at a particular planned time. As mentioned, the bookings or selections can be made by the route manager automatically based on various criteria, among other such options.

As mentioned, users can either suggest route information or provide information that corresponds to a route that would be desired by the user. This can include, for example, an origination location, a destination location, a desired pickup time, and a desired drop-off time. Other values can be provided as well, as may relate to a maximum duration or trip length, maximum number of stops, allowable deviations, and the like. At least some of these values may have maximum or minimum values, or allowable ranges, specified by one or more route criteria. There can also be various rules or policies in place that dictate how these values are allowed to change with various circumstances or situations, such as for specific types of users or locations. The route manager 414 can receive several such requests, and can attempt to determine the best selection of routes to satisfy the various requests. In this example the route manager can work with a route generation module 418 that can take the inputs from the various requests and provide a set of route options that can satisfy those requests. This can include options with different numbers of vehicles, different vehicle selections or placements, different modes of transportation, different segment options, and different options for getting the various customers to their approximate destinations at or near the desired times. It should be understood that customers may also request for specific locations and times where deviation is not permissible, and the route manager may need to either determine an acceptable routing option or deny that request if minimum criteria are not met. An option can be provided for each request, and a pricing manager 422 can determine the cost for a specific request using pricing data and guidelines from a price repository 424, which the user can then accept or reject.

In this example, the route generation module 418 can generate a set of routing options based on the received requests for a specified area over a specified period of time. A route optimization module 420 can perform an optimization process using the provided routing options to determine an appropriate set of routes to provide in response to the various requests. Such an optimization can be performed for each received request, in a dynamic routing system, or for a batch of requests, where users submit requests and then receive routing options at a later time. This may be useful for situations where the vehicle service attempts to have at least a minimum occupancy of vehicles or wants to provide the user with certainty regarding the route, which may specify a quorum of riders for each specific planned route. An objective function is applied to each potential route in order to generate a route “quality” score, or other such value. The values of the various options can then be analyzed to determine the routing options to select. The route optimization module 420 applies the objective function to determine the route quality scores and then can select the set of options that provides the highest overall, or highest average, total quality score. Various other approaches can be used as well as would be understood to one of ordinary skill in the art in light of the teachings and suggestions contained herein.

The objective function can be implemented independent of a particular implementation of an optimization algorithm. Such an approach can enable the function to be used as a comparative metric of different approaches based on specific inputs. Further, such an approach enables various optimization algorithms to be utilized that can apply different optimization approaches to the various routing options to attempt to develop additional routing options and potential solutions, which can help to not only improve efficiency but can also potentially provide additional insight into the various options and their impact or interrelations. An optimization console can be utilized that displays the results of various optimization algorithms, and enables a user to compare the various results and factors in an attempt to determine the solution to implement, which may not necessarily provide the best overall score. For example, there might be minimum values or maximum values of various factors that are acceptable, or a provider might set specific values or targets on various factors, and look at the impact on the overall value and select options based on the outcome. The user can view the results of the objective function as well, before any optimization is applied, in order to view the impact of various factor changes on the overall score. Such an approach also enables a user or provider to test new optimization algorithms before selecting or implementing them, in order to determine the predicted performance and flexibility with respect to existing algorithms.

Further, such an approach enables algorithms to evolve automatically over time, as may be done using random experimentation or based on various heuristics. As these algorithms evolve, the value of the objective function can serve as a measure of fitness or value of a new generation of algorithms. Algorithms can change over time as the service areas and ridership demands change, as well as to improve given the same or similar conditions. Such an approach may also be used to anticipate future changes and their impact on the service, as well as how the various factors will change. This can help to determine the need to add more vehicles, reposition parking locations, and so forth.

Artificial intelligence-inclusive approaches, such as those that utilize machine learning, can be used with the optimization algorithms to further improve the performance over time. For example, the raising and lowering of various factors may result in a change in ridership levels, customer reviews, and the like, as well as actual costs and timing, for example, which can be fed back into a machine learning algorithm to learn the appropriate weightings, values, ranges, or factors to be used with an optimization function. The optimization function itself may be produced by a machine learning process that takes into account the various factors and historical information to generate an appropriate function and evolve that function over time based upon more recent result and feedback data, as the machine learning model is further trained and able to develop and recognize new relationships.

Various pricing methods can be used, and the pricing can be used as a metric for the optimization. For example, the cost factors can be evaluated in combination with one or more revenue or profitability factors. For example, a first ride option might have a higher cost than a second ride option, but might also be able to recognize higher revenue and generate higher satisfaction. Certain routes for dedicated users with few to no intermediate stops might have a relatively high cost per rider, but those riders might be willing to pay a premium for the service. Similarly, the rider experience values generated may be higher as a result. Thus, the fact that this ride option has a higher cost should not necessarily have it determined to be a lower value option than others with lower cost but also lower revenue. There can be pricing parameters and options that are factored into the objective function and optimization algorithms as well. Various pricing algorithms may exist that determine how much a route option would need to have charged to the individual riders. The pricing can be balanced with consumer satisfaction and willingness to pay those rates, among other such factors. The pricing can also take into various other factors as well, such as tokens, credits, discounts, monthly ride passes, and the like. There might also be different types of riders, such as customer who pay a base rate and customers who pay a premium for a higher level of service. These various factors can be considered in the evaluation and optimization of the various route options.

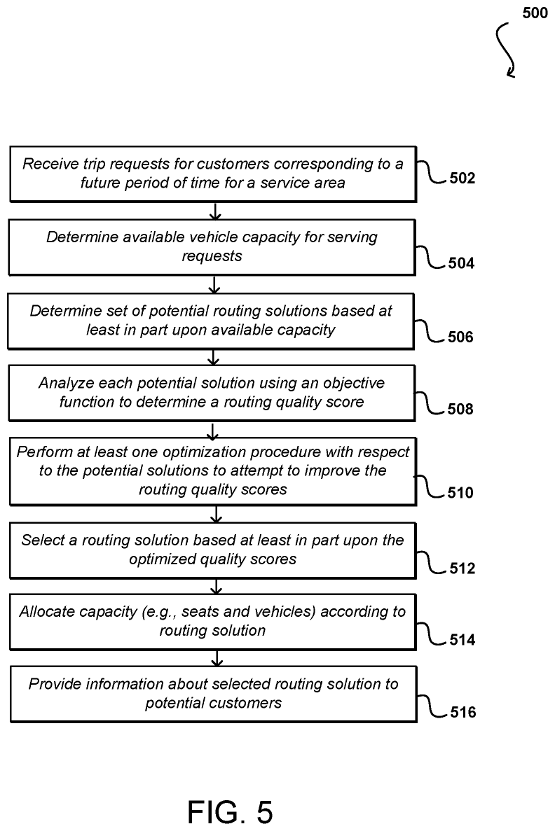

For any of the segments or full journeys, requests can be received for a number of potential riders and the best set of options can be determined that satisfies the customer requests but also satisfies various business specifications as discussed herein. FIG. 5 illustrates an example process 500 that can be used to determine various routing options to serve a set of rider requests. It should be understood that, for this and other processes discussed herein, there can be additional, fewer, or alternative steps, performed in similar or alternative steps, or in parallel, unless otherwise stated. As mentioned, various other route determination and optimization approaches can be used as well. In this example, a number or journey or trip requests are received 502 from, or on behalf of, various potential customers of a transportation service. The requests in this example relate to a future period of time, for at least one specified service area or region, in which the transport is to occur for one or more persons, animals, packages, or other objects or passengers. The requests can be submitted through an application executed on a computing device, although other request mechanisms can be used as well. In order to determine how to best serve the requests, this example process first determines 504 available vehicle capacity for serving the requests. This can include, for example, determining which vehicles or transport mechanisms are available to that service area over the specified future period of time, as well as the available seating or other capacity of those vehicles for that period of time. As mentioned, at least some of the seats of the various vehicles may already be committed or allocated to specific routes, riders, packages, or other such options.

Based at least in part upon the various available vehicles and capacity, a set of potential routing solutions can be determined 506. This can include, for example, using one or more route determination algorithms that are configured to analyze the various origination and destination locations, as well as the number of passengers and corresponding time windows for each, and generate a set of routing solutions for serving the various requests. The potential solutions can attempt to allocate vehicles to customers based on, for example, common or proximate origination and destination locations, or locations that can be served by a single route of a specific vehicle. A routing algorithm can potentially analyze all possible combinations for serving the requests with the available vehicles and capacity, and can provide any or all options that meet specific criteria, such as at least a minimum utilization or profitability, or at most a maximum allowable deviation (on average or otherwise) from the parameters of the various customer requests. This can include, for example, values such as a distance between the requested origination location and a suggested pick up point, deviations from a requested time, and the like. All potential solutions can be provided for subsequent analysis, or a subset thereof.

In this example process, the various potential routing solutions can be analyzed 508 using an objective function that balances various factors, such as provider efficiency and customer satisfaction, or at least takes those factors into consideration as discussed elsewhere herein. Each potential routing solution that is analyzed using the function, or at least that meets specific minimum criteria, can be provided with a routing quality score generated inserting the relevant values for the solution into the objective function. This can include, for example determining a weighted combination of various quality factors as discussed herein. The solution with the best (e.g., highest or lowest) quality score can be selected for implementation. In this example, however, at least one optimization procedure is performed 510 with respect to at least some of the potential solutions. The process might be performed for all potential solutions, while in others only a subset of the solutions will go through an optimization procedure, where solutions with a quality score outside an acceptable range may not be considered for optimization in order to conserve time and resources. The optimization process can attempt to improve the quality scores of the various solutions. As discussed herein, an optimization process can attempt to adjust various parameters of the solution, such as to adjust pickup times, stops per route, capacity distribution, and the like. As mentioned, multiple optimization procedures may be applied, where the algorithms may look at different factors or adjustable ranges, and so forth. Different optimization algorithms may also optimize for, or prioritize, different factors, such as different QoS or efficiency components, profitability, rider comfort, and the like.

After the optimization, at least some of the various proposed solutions may have updated quality scores. Some of the proposed solutions may also have been removed from consideration based on, for example, unacceptable quality scores or an inability to adequately serve a sufficient number of the pending requests, among other such factors. A specific routing solution can then be selected 512 from the remaining solutions, where the solution can be selected based at least in part upon the optimized quality scores. For example, if optimizing for factors such as profitability or customer satisfaction rating, it can be desirable to select the option with the highest score. If optimizing for factors such as cost, it might be desirable to select the option with the lowest score. Other options can be utilized as well, such as to select the score closest to a target number (e.g., zero). As mentioned, other factors may be considered as well. For example, a solution might be selected that has close to the best quality score, but has a much better profitability or customer satisfaction value, or satisfies one or more other such goals or criteria. Once the solution is determined, the appropriate capacity can be allocated 514 based upon vehicles and seating, among other potential options, determined to be available for the determined region at, or near, the future period of time. This can include, for example, determining routes and stops, and assigning vehicles with appropriate capacity to specific routes. The assignment of specific types of vehicles for certain routes may also be specified in the routing options, as there may be certain types of vehicles that get better gas mileage in town and some that get better gas mileage on the highway, for example, such that operational costs can be broken down by types of vehicles as well. Specific vehicles might also be due to service for a specific mileage target, which can be factored in as well as other factors, such as cost per mile, type of gasoline, fuel, or power utilized, and the like. Information about the selected routing option can then be provided 516 to particular customers, such as those associated with the received requests. The information can indicate to the users various aspects such as the time and location of pickup, the route being taken, the location and approximate time of arrival at the destination, and potentially information about the specific vehicle and driver, among other such options.

Another aspect of the present disclosure pertains to a rideshare platform that can accommodate passengers with special needs. Historically, rideshare platforms have not been successful in providing reliable or accessible transportation to many passengers with special need(s). Many rideshare vehicles are also unsuitable for accommodating certain types of passengers. For example, passengers use a wheelchair may be unable to load into vehicles without a ramp or lift. Even if a rideshare service has vehicles that can accommodate passengers with special needs, a failure to keep track of special needs passengers can result in a vehicle being overbooked. For example, if a passenger has a service animal that occupies a seat, another passenger may be prevented from loading the vehicle. The specifications for loading, unloading, the extra time needed for loading and unloading, and other services provided for special needs passengers may deter regular passengers from using the rideshare service. Some passengers may feel dissatisfied if they reason that their trip is being held up by passengers with specials needs. These passengers may eventually look to other transportation options. Since passengers having special needs may specify additional space, supplying a fleet of vehicles that can accommodate these passengers can also cut into the profit of the rideshare service. For example, in order to configure a vehicle with a wheelchair lift and docking station, more than one regular seating position may need to be removed from the vehicle. The following description pertains to a rideshare platform that is suitable for providing services for both passengers with and without special need(s).

To accommodate special need(s), passengers can be classified based on a set of respective needs and/or services which have been requested, or that have otherwise been determined. As used herein, a passenger's travel needs refer to the accommodations and/or services needed or otherwise deemed helpful for a passenger. Passenger classification, or determination of a passenger's travel needs, can occur at or prior to the time at which a travel request is made so that appropriate routing options can be determined. If a passenger's travel needs are not determined until the time for which the request is to be satisfied, there may need to be some amount of adjustment or reconfiguration necessary to accommodate the special need. In some cases, accommodating the needs of one passenger may specify rerouting one or more other passengers.

There are a variety of travel needs that customers may have when making a travel request with a rideshare service. In many cases, extra space may be needed to accommodate certain passengers. For example, additional space may be needed for transporting medical equipment, a walker, a baby stroller, and the like. In some cases, passengers may indicate vehicles to be equipped with safety equipment such as a booster seat or a car seat in order to accommodate a child or a short passenger. Passengers in wheelchairs may indicate a wheelchair docking station. Some passengers may have a service animal such as a dog. Some passengers may need to be loaded or unloaded from specific locations. For instance, a frail passenger may need to be dropped off closer to their final destination if a standard route endpoint is too far away. Some passengers may need an extra seat or a bigger seat if they are overweight. Providing a comfortable seat for such a passenger would, at the very least, improve the experience of all passengers in the vehicle. Some passengers, such as those in wheelchairs, may indicate a lift or a ramp to be able to load and unload from a vehicle. Some passengers may need physical assistance in order to enter or exit a vehicle. Blind passengers may need help finding a vehicle and may need to be guided to the vehicle. Some passengers may become nauseous when facing sideways or backward and may need a forward facing seat. This non-limiting list of needs that passengers may have illustrates how a one size fits all approach does not work when providing transportation to such customers. By classifying passengers according to their needs, the rideshare platform can adjust routes as necessary to accommodate passengers with special needs while still providing an efficient service for regular customers.

Passengers may provide information describing their travel parameters through a website or mobile application, by calling customer service, and the like. In some cases, a passenger's travel parameters are saved to an account or user profile that can be used to submit travel requests so that the user does not have to provide this information each time a travel request is made. A customer may be able to submit temporary travel parameters when booking a route to account for a short-term need. For example, a passenger with a broken foot may request wheelchair accommodations for a specific travel request rather than changing default settings used for booking travel requests.

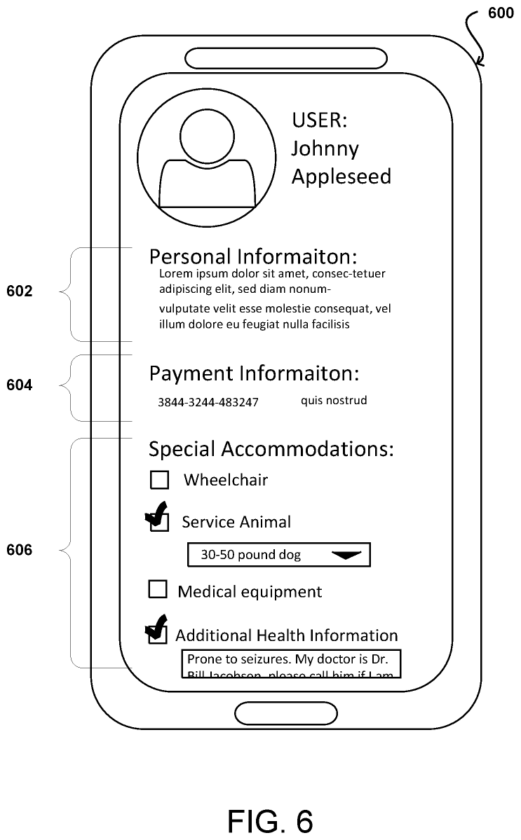

FIG. 6 shows an interface of a mobile application running on device 600 which can be used to record a customer's request for special accommodations. In some cases, a user profile page containing personal information 602 or payment information 604 may also include a section for a user to provide information regarding additional accommodations or services needed 606. Information provided can be helpful in determining what vehicles are suitable for the passenger, what locations can be used for loading and unloading, what additional help a passenger needs, emergency contact information, and the like. In the depicted interface, a user has selected an option indicating that he desires a service animal. In some cases, further options can be provided for a user to classify the service animal, upload documents showing records pertaining to the service animal, or explain why the service animal is desired. Besides a mobile or web-based application, there may be various other means of collecting information needed to classify passengers. For example, when boarding a vehicle, a driver may recognize that a passenger needs or would benefit from special accommodations. The driver could save this information to a database or profile associated with the user so that future travel requests will specify the special needs of the passenger. In some cases, a passenger's travel parameters can be determined by referencing a publicly accessible online profile and/or database associated with the user. In some cases, a user may choose to link an account used for creating travel requests with another account that has information regarding the passenger's special needs.

The application may provide an option for a user to provide additional information relating to the user's health conditions. For example, a user may choose to provide emergency contact information, a doctor's contact information, or information related to a health condition. For instance, if a passenger knows that they are at risk of having an epileptic seizure, they may describe their condition and provide instructions for using an Epinephrine Auto-Injector that they carry. If that passenger has a seizure, the driver or other staff would then be able to access relevant instructions through the application for providing treatment or getting in contact with appropriate emergency contacts or medical professionals.

Rather than providing information specific to the user's health information, a user may select suitable transportation accommodations from a listing of options. For example, a user may be presented with a description of different vehicles and seating arrangements from which the user can select suitable options. In some cases, a picture or schematic of a vehicle arrangement can be displayed and a user can select, e.g., whether a wheelchair location is suitable, whether a larger seat is preferable, or whether only the forward facing seats are suitable. In some cases, a customer may provide a written description or converse with an employee of the rideshare service who can make an appropriate selection of the accommodations desired.

Users with special needs may be provided with adjusted pricing based on a health condition and/or requested services. For example, if the rideshare service partners with and receives funding from a governmental agency for providing transportation to disabled citizens, disabled passengers may be charged a reduced rate. In another situation, if a passenger would like to bring an emotional support animal, that customer may be charged an additional fee. In some circumstances, a passenger may only qualify for a reduced rate or avoid an increased rate if they can provide appropriate paperwork such as a signed form provided by a medical professional. In some cases, such paperwork can be uploaded to the user's account by using the mobile application.

Once a customer has provided their special needs to the rideshare platform, e.g., through a mobile application, these needs may be saved for future bookings. The information that is provided by the user, or is in some other way collected for the user, can then be used to determine the travel needs of the passenger. Once a passenger has been identified as a particular passenger type, the passenger type can be used when determining routing information. If a passenger type indicates that the passenger is wheelchair bound, wheelchair accommodations may be selected and applied for the passenger.

In some cases, the travel parameters for passengers are stored locally on a mobile device and submitted along with each travel request made from the device. In some cases, a database is used to store travel parameters for passengers who have previously booked rides with the rideshare service. In some cases, by aggregating the passenger data from past trips, the rideshare platform can optimize routes and/or vehicle configurations for customers who repeatedly use the rideshare service.

In order to accommodate the special needs of potential customers, at least some vehicles need to be configured to accommodate for each passenger type. A rideshare service may have a fleet of vehicles of different models and configurations. For example, some vehicles may be equipped with wheelchair lifts and wheelchair docking stations, while other vehicles may have additional space for service animals or may have booster seats or car seats available if needed. Vehicles may be equipped to accommodate a variety of passenger types, or in some cases may only be equipped for accommodating a select subset of passenger types. A fleet of vehicles may include large vehicles that can transport a higher number of users (e.g., more than 15 passengers) and, in some cases, at least smaller vehicles which can navigate narrow roads and tight turnarounds. It may not be cost effective or beneficial for each vehicle to be able to accommodate each of the special needs that may be requested. For example, if vehicles are equipped with wheelchair docking stations and ramps, the maximum occupancy of the vehicle may be reduced. If every vehicle were equipped with a wheelchair ramp and docking station, additional vehicles might be needed.

In some cases, a vehicle may be may be configured to accommodate more than one passenger type. In some cases, a vehicle may be easily reconfigurable so that it can be easily reconfigured to accommodate a passenger with special needs after a travel request has been received or at the time the passenger loads the vehicle. For instance, a vehicle may have a bench seat or a bucket seat that can be removed from the vehicle or can be collapsed into the floor of the vehicle to make room for a wheelchair, a service animal, or some item belonging to a customer. In one example, the seat is automatically actuated using mechanically actuated members. The seat can be operable to transition between a deployed position and a stored position using the mechanically actuated members. The seat can be transitioned between the deployed and stored positions by depressing a button or lever within the cabin of the vehicle. Alternatively, the seat can be transitioned between the deployed and stored positions automatically when a signal is received. For example, a service provider, such as a fleet manager (see fleet manager 430 of FIG. 4), can transmit instructions to an available vehicle to reconfigure the seat or space to satisfy the suitable vehicle configuration. These signals can be used to reserve a seat or space satisfying the suitable vehicle configuration, as well as reconfigure the seat or space to satisfy the suitable vehicle configuration. In one example, the seat is reconfigured by a vehicle controller of a vehicle (see vehicle 202 of FIG. 2) to activate a mechanically actuated seat, causing it to collapse. When the seat is collapsed, a user in a wheelchair can occupy the space provided above the collapsed seat.

In some cases, a vehicle may have one or more seats that can be can be adjusted up, down, forward and/or backward so that passengers can be safely positioned in the case of airbag deployment. In some instances, moveable seats can be adjusted to create additional legroom or create space for a service animal. In some cases, a vehicle includes at least one passenger seat attached to an articulating arm which allows the seat to be lowered outside the vehicle. In such cases, passengers (e.g., passengers in wheelchairs or passengers who might otherwise have difficulty entering the vehicle) can be loaded and unloaded from a vehicle in a seated position. In certain cases, customers with special needs may be given a higher weighting factor than regular customers when routes are determined. This may be done, e.g., to offset a reduction in the quality of service when only a subset of vehicles are suitable for providing transport for the passenger. Vehicles may be adaptively reconfigured over time so that the fleet of vehicles used for a rideshare service is optimized for a particular user base. Historical ride data (e.g., the number of rides, the average wait time, the average transit time, and the like) for both regular passengers and passengers with special needs can be used to determine how vehicles should be configured to best accommodate and provide services to both special needs customers and regular customers.

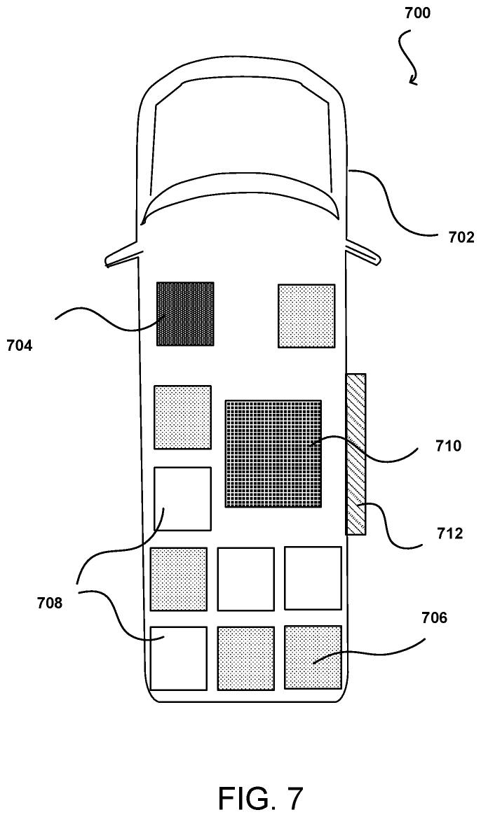

FIG. 7 depicts an example configuration 700 of a vehicle 702 configured to accommodate certain special needs requests. In the depicted state, vehicle 702 includes space 704 for a driver and seats or other capacity for up to a maximum number of riders. For a given vehicle on a given route, a number of available seats 706 (or other rider locations) may be occupied by riders, while another number of seats 708 may be unoccupied. In the depicted state, vehicle 700 is equipped with a space 710 that can be used by a wheelchair, a service animal, or another passenger item. A lift 712 is also depicted which may be used for loading and unloading passengers in wheelchairs who might otherwise have difficulty getting into or out of the vehicle. The vehicle can be reconfigured so that it resembles the seating arrangement of vehicle 200 in FIG. 2. For instance, if space 710 is not needed for a customer, then seats may fold out of the floor of the vehicle to increase the maximum occupant capacity of the vehicle. It should be understood that various types of vehicles can be used with different numbers or configurations of capacity, and that autonomous vehicles without dedicated drivers can be utilized as well.

One difficulty in providing services for passengers with special needs is that many locations may be unsuitable and potentially dangerous for loading and/or unloading passengers with special needs. For example, a passenger in a wheelchair may find it difficult to load or unload on a steep incline. In another case, an elderly passenger may need to be unloaded from the vehicle within a manageable walking distance of a final destination. In some cases, loading and unloading locations are only suitable under certain conditions. For example, a location may be unsuitable for some passengers at night if it becomes difficult to see, during adverse weather conditions which may increase a passenger's risk of falling, or during high traffic hours if a passenger is indicated to cross a busy street. In some cases, a location may become unsuitable for a short season during the year. For example, a loading and unloading zone may become unsuitable during the winter due to ice if a sidewalk is not cleared and salted, or may be unsuitable if a construction project blocks a sidewalk.

In some cases, loading and unloading locations can be classified to indicate what type of passengers can be loaded or unloaded at the particular location. Classification of pick up and drop off locations can be done by manual inspection, and in some cases, classification can be done remotely via inspection of satellite imagery or other mapping data such a Google's street view. In some cases, drivers and passengers may be able to rate locations so that better locations are identified over time. In some cases, users can flag hazards associated with certain locations which may make a location unsuitable for some passengers. For example, while a location may be great for able-bodied passengers, a location can be flagged as being hazardous for a certain type of passenger such as those in wheelchairs. In some cases, users may be able to take a picture of the hazard on and submit the photo to the ridesharing platform through a mobile application. Rating and flagging systems can be helpful in determining temporary conditions that make a location unsuitable for certain types of passengers. For instance, a feeble passenger may find a loading or unloading location inappropriate during rush-hour traffic if the location specifies that the user may cross a street without a light for stopping traffic.

The rideshare service may provide flexible loading and unloading locations for users with special needs. In some cases, regular passengers may be picked up and dropped off at standard locations, and a vehicle will make additional stops for passengers with qualifying needs. In some cases, if a passenger with special needs has requested a drop off or pick up location that is nearby a standard location, other passengers may be instructed to be picked up or dropped off from the selected location. When an unloading location is selected due to a special needs passenger, other vehicles which are scheduled to move passengers on the next leg of their journeys may be re-routed from a regular stopping location to the selected location based on the passenger with special needs. Such adjustments may be done to so that an additional stop can be avoided.

As mentioned if a passenger with special needs submits a travel request, the routes of other passengers may, in some cases, be affected in order to accommodate the passenger's travel parameters. For instance, other passengers may need to change vehicles so that the special needs passenger can be accommodated. In some cases, loading and/or unloading locations may be changed, the legs of a passenger's journey may be updated, and timing information associated with a passenger's journey may be adjusted. As discussed elsewhere herein, when a passenger's route is updated, the passenger may be notified in a variety of ways such as a notification on a mobile application, a text message, or through a vehicle's speaker system. In some cases, a passenger may be notified of the reason for the change. In some cases, passengers may not be notified of the reason for the routing change so that the passenger does not know whether the change was made in order to accommodate a passenger with special needs or if the change was due to a traffic delay. In cases when a loading or unloading location altered to accommodate a special need of one passenger, other passengers may be requested to unload at the revised drop off location. In some cases, these passengers may be provided with an option to request an additional stop at the regular drop off location if, e.g., they feel that they would be inconvenienced by being dropped off at the new drop off location.

A rideshare service may apply rules to passenger types with certain travel parameters when determining potential routing options. These rules can guarantee that the needs of a customer are met and help avoid situations that may adversely affect the travel experience of customers. As mentioned, in some cases, rules applied to certain users may re-route other users so that a special need can be accommodated. Several non-limiting examples of rules are now presented.

In some cases, regular users may feel inconvenienced if a passenger takes several minutes to load into a vehicle (e.g., if they need to use a lift). One rule that can be used to help mitigate user dissatisfaction would be to specify that passenger types that take longer than a threshold amount of time to be picked up at the first stop and/or dropped off at the last stop along a route so that other passengers do not feel delayed. In some cases, a rule may be applied so that a particular passenger type will only be routed using a vehicle if the vehicle is below a threshold capacity—so that fewer regular customers will be inconvenienced by the slow loading time of the passenger. Another rule that can be used establishes a route (in some cases only a temporary or single-use route) based on the travel request of a passenger with special needs. Other passengers can then be picked up and dropped off along the route if they happen to be traveling at least in the same direction for a part of the route. This type of rule could be used to eliminate mid-route transfers for a passenger with special needs and make the travel experience better for all customers.

In some cases, a rule might state that a customer with certain travel parameters may have a maximum number of allowable transfers. For example, a rule can be used to specify passengers in wheelchairs to have less than two total transfers. Alternatively, a rule might specify that a passenger have less than a certain number transfers per passenger mile. For example, a rule could specify that a passenger have less than one transfer per 15 miles traveled.

In some cases, rules are used to determine which vehicles can be used for certain passenger types. For instance, a passenger who uses a wheelchair may have a rule that specifies him or her to travel in a vehicle with a ramp or a wheelchair lift.

In some cases, a passenger rule can limit what loading and unloading locations can be used for a particular passenger type. For instance, an elderly passenger may need to be dropped off within a certain distance of their intended destination, forcing the vehicle to change an offloading location or to make an additional stop. As another example, a blind passenger may become confused if they are dropped off at an unfamiliar location, thus a blind passenger may have a rule that specifies that they can only be dropped off at standard locations or locations that are known to the passenger.

In some cases, rules for a first passenger may conflict with rules for a second passenger. In such cases, routing instances, routing algorithms may suggest and/or specify the second passenger to take a separate route, e.g., such that the passengers are not in the same vehicle. In some cases, rules associated with one passenger type are prioritized over rules associated with another passenger type.

A rule may assign a passenger type with a higher weighting factor so that the user is prioritized when routing options are determined based on a plurality of travel requests. In some cases, an optimization algorithm may consider the higher weighting factors assigned to users when optimizing routes. For instance, an optimization algorithm may attempt to reduce the number of transfers or reduce the travel time for a person with special needs in accordance with a weighting factor which they are given.

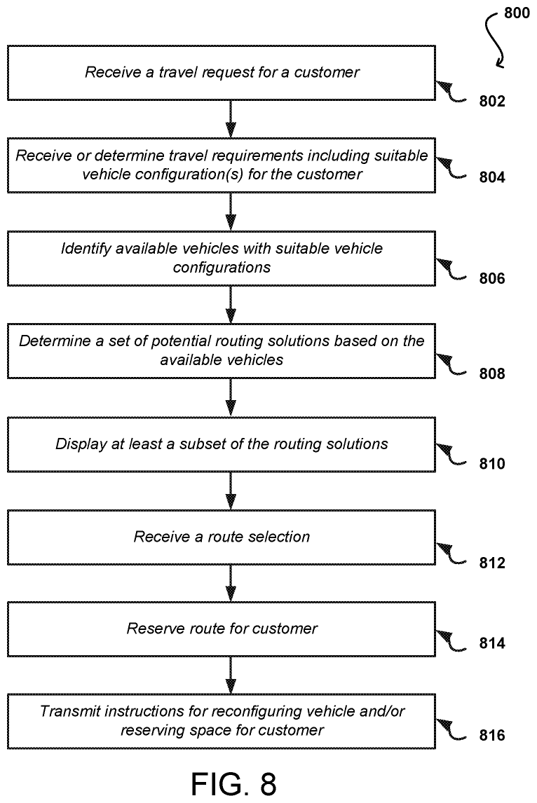

FIG. 8 illustrates an example method according to some embodiments. Example method 800 demonstrates a process for determining routes for customers with special vehicle configuration needs. In operation 802 a travel request is received from a customer. The travel request may include origin information (e.g., provided via GPS enabled device), destination information (e.g., as selected through an application on a mobile device), user information (e.g., a customer ID, or information related to special accommodations needed), and a time component (e.g., a requested time of departure or time of arrival). In operation 804 acceptable vehicle configurations (and other travel parameters if any) are received or determined. As mentioned, they may be received along with the travel request when a travel request is provided from a client device. For instance, a customer in a wheelchair may identify that they need wheelchair accessibility. In some cases, the travel parameters may be stored in a database and accessed when a travel request from a customer (e.g., identified by a customer ID) is received. In some cases, the travel parameters, including a vehicle parameter or attribute) may need to be determined based on information provided by the customer. For example, based on age information and/or health information, logic may be used to determine that a passenger likely needs help getting into and out of a vehicle and should have a seat reserved near a door.

Once the acceptable vehicle configurations (and other travel parameters if any) are known, a set of one or more available vehicles are identified that satisfy the vehicle configurations 806. Suitable vehicles are vehicles that are currently configured to an acceptable vehicle configuration or can be re-configured to do so. For instance, some vehicles may have seats that can be repositioned to make room for a wheelchair. In some cases, the origin or destination information in combination with pick up or drop off specifications may limit the length of acceptable vehicles in order to navigate a road safely. The operation of identifying suitable vehicles may consider the number of seats on the vehicle that satisfy a configuration needed by the customer, and whether there are other passengers with similar travel parameters who will be on the vehicle during the same leg of the customer's itinerary.

In operation 808 a set of potential routing solutions are determined for the customer based at least in part on the available suitable vehicles that have been identified. This can include, for example, using one or more route determination algorithms that are configured to analyze the various origination and destination locations, as well as the number of passengers and corresponding time windows for each, and generate a set of routing solutions for serving the various requests. Potential solutions can be provided for subsequent analysis. Further, for multi-segment routing options, the route determination algorithm can take into account possible connection points, as well as the possible routing options from those connection points to the target destination, including the appropriate time windows for each.

In operation 810 at least a subset of the routing solutions are displayed or otherwise provided to the customer. The routing solutions are ranked based on a total trip time, a convenience score, a cost score, a quality of service score, or some other relevant metric. The ranking may be based on one or more user selected metrics. For instance, the user might select to configure an application so that rankings depend primarily on the trip cost and/or the trip duration. Only a single routing option is displayed in one example. Routing options can be displayed along with one or more metrics associated with the route such as cost, number of transfers, and duration.

In operation 812 a route selection is received from the user. For instance, using the client device, a customer may review the displayed routing solutions and pick a preferred route. A user may configure rules that automatically book the shortest routing solution, cheapest routing solution, or the routing solution with the least number of transfers. After receiving a routing selection, the route is reserved for the customer 814. A specific seat which meets the customers travel parameters can be reserved. In step 816, instructions for reconfiguring the vehicle or reserving a space for the customer are transmitted to the vehicle or vehicle's driver. For instance, a driver at may receive a notification indicating that in two stops a passenger in a wheelchair will be loading and that the vehicle should be reconfigured at the earliest convenience (e.g., by collapsing a seat in the floor of the vehicle). The driver could then notify other passengers that the wheelchair space is reserved. The driver might even be able to reconfigure the seat ahead of time (if reconfiguration is needed) so that the customer in the wheelchair can be quickly loaded. In some cases, a vehicle can be reconfigured automatically without requiring the assistance of a driver. In some cases, a vehicle may have indicators showing that a particular seat is reserved. A screen, for instance, might even provide the customer's name or some other identification to reserve the space.

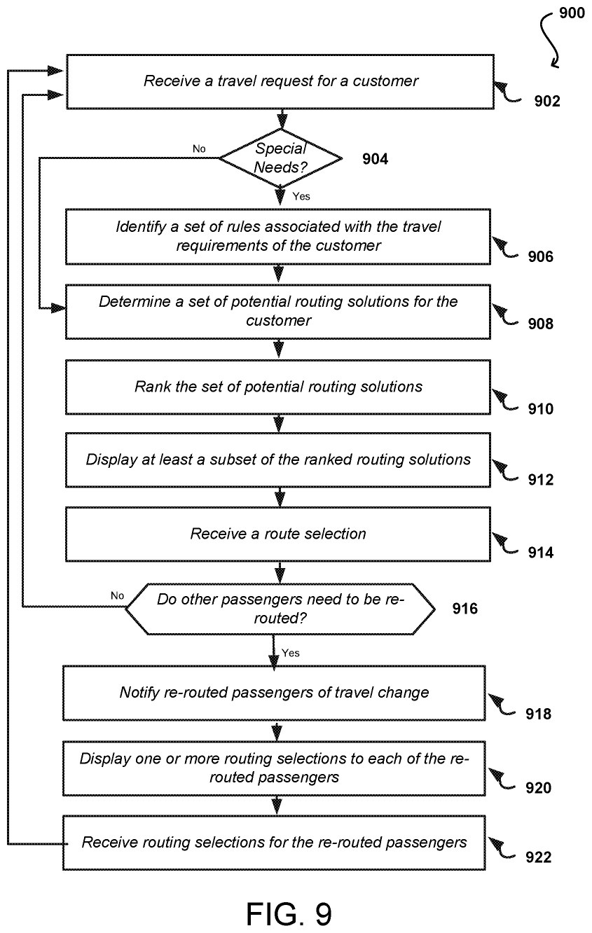

FIG. 9 illustrates an example method 900 that illustrates a process for selecting routes for users with and without special needs. In operation 902 a travel request is received from the customer. The travel request may include origin information (e.g., provided via GPS enabled device), destination information (e.g., as selected through an application on a mobile device), passenger information (including information associated with travel parameters), and a time component (e.g., a requested time of departure or time of arrival). At operation 904 it is determined, based on the passenger type information, whether the passenger has any special needs that need to be accounted for when making a routing decision. If the passenger has not indicated any travel parameters, the process jumps to operation 908. However, if a passenger has shown that they have special needs, a set of rules associated with the needs of the user are identified 906.

In operation 908, a set of potential routing solutions are determined for the customer. If rules have been identified for the customer, the set of potential routing solutions are determined based at least in part on the set of rules. Determining the potential routing solutions for a passenger with special needs may involve operations of, e.g., identifying suitable vehicles for the customer, identifying suitable loading and unloading locations for the customer, identifying currently planned routes by other customers, and identifying other passenger types associated with the currently planned routes. One or more route determination algorithms are used that are configured to analyze the various origination and destination locations, as well as the number of passengers and corresponding time windows for each, and generate a set of routing solutions for serving the various requests. All, or a subset of, potential solutions can be provided for subsequent analysis. Further, for multi-segment routing options, the route determination algorithm can take into account possible connection points, as well as the possible routing options from those connection points to the target destination, including the appropriate time windows for each.

Once the possible routes are determined they are ranked 910 based on, e.g., a total trip time, a convenience score, a cost score, a quality of service score, or some other relevant metric. The ranking may be based on one or more user selected metrics. For instance, the user might select to configure an application such that rankings depend primarily on the trip cost and/or the trip duration. After the routing solutions are ranked, at least a portion of the routing solutions are displayed or otherwise presented to a user 912. Only a single routing option is displayed. In some cases, routing options are displayed along with one or more metrics associated with the route such as cost, number of transfers, and duration. In operation 914, a route selection is received from the user and the route is reserved for the user.

At operation 916, it is determined whether other passengers who may have already submitted travel requests need to be re-routed. As mentioned, in some cases, passengers may be re-routed to accommodate a travel request for a person with special needs. For instance, an unloading location may be moved due in part to a rule associated with the needs of the passenger with special needs. If it is determined that there are passengers who will have their routes modified, these passengers are notified 918. Notifications can occur, e.g., via text message, through a mobile app, or through a speaker system of a vehicle. Having been notified of the change, these users may be presented with one or more re-routing options 920 from which these passengers can make a re-routing selection. If a re-routed passenger has a set of rules corresponding to a travel parameter, the re-routing options will be based on at least in part on corresponding rules. If, for example, the unloading location is moved by one block, an option may be presented to users requesting acknowledgment of the change. In some cases, if the switch creates an inconvenience, the user may have an option to request an additional stop at the previously scheduled location. When a change is relatively minor, such as when the unloading location has only been moved a short distance, a user may not need to provide a selection. After selections have been received for the re-routed passengers 922, or in the case where it is determined that no passengers need to be re-routed in operation 916, the method 900 can return to the step of receiving a new travel request for additional passengers 902.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” and the like indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that stores computer-executable instructions is computer storage media (devices). Computer-readable media that carries computer-executable instructions is transmission media. Thus, by way of example, and not limitation, implementations of the present disclosure can comprise at least two distinctly different kinds of computer-readable media: computer storage media (devices) and transmission media.

Computer storage media (devices) includes RAM, ROM, EEPROM, CD-ROM, solid state drives (SSDs) (e.g., based on RAM), flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

What is claimed is:

1. A method, comprising:
receiving a transportation request for a customer, the transportation request comprising a travel parameter of the customer having information that is indicative of a physical limitation of the customer;
determining a suitable vehicle configuration based on the travel parameter;
identifying an available vehicle having a seat or space satisfying the suitable vehicle configuration;
transmitting instructions to the available vehicle to reconfigure the seat or space to satisfy the suitable vehicle configuration;
receiving a route selection; and
transmitting instructions to the available vehicle that are used for:
reserving the seat or space satisfying the suitable vehicle configuration; or
reconfiguring the seat or space to satisfy the suitable vehicle configuration.

2. The method of claim 1, wherein reconfiguring the seat or space occurs automatically and can include collapsing or folding of the seat.

3. The method of claim 2, wherein reconfiguring the seat or space comprises adding or removing the seat from the available vehicle.

4. The method of claim 1, wherein identifying the available vehicle comprises determining if the seat or space satisfying the suitable vehicle configuration has been reserved by another passenger.

5. The method of claim 1, further comprising:
determining a set of potential routing solutions using the available vehicle;
displaying a subset of the set potential routing solutions; and
determining a rule associated with the travel parameter, the rule not being the suitable vehicle configuration, wherein the set of potential routing solutions is based on the rule.

6. The method of claim 1, wherein reserving the seat or space satisfying the suitable vehicle configuration comprises reserving a second or third seat in addition to seat or space when the physical limitation of the customer includes use of a wheelchair.

6. A method, comprising:
receiving a transportation request for a first customer, the transportation request specifying at least an origin, a destination, a travel parameter associated with a special need of the first customer, and a time component, the travel parameter comprising information indicative of a physical limitation of the first customer;
determining a suitable vehicle configuration based on the travel parameter;
identifying an available vehicle having a seat or space satisfying the suitable vehicle configuration;
determining a rule based on the travel parameter for the available vehicle;
identifying a potential routing solution for the first customer based on the rule;
receiving a route selection from the potential routing solution; and
reserving the route selection for the first customer.

7. The method of claim 6, wherein the rule is based on an estimated loading time and/or unloading time for the first customer.

8. The method of claim 6, wherein the rule indicates that vehicles used to transport the first customer have less than a threshold number of passengers in the vehicle.

9. The method of claim 6, wherein the rule indicates that vehicles used to transport the first customer have additional space for any of medical equipment, a service animal, a baby stroller, a booster seat, and a baby car seat.

10. The method of claim 6, wherein the rule indicates the potential routing solution to be a new route starting at the origin and ending at the destination.

11. The method of claim 6, wherein the rule limits a number of times that the first customer can be transferred between vehicles.

12. The method of claim 6, wherein the rule indicates the first customer to be loaded or unloaded at a specific location, the specific location not being a standard loading or unloading location.

13. The method of claim 13, further comprising charging the first customer for the route section, wherein an amount that the first customer is charged is based in part on the rule.

14. The method of claim 14, further comprising:
receiving information about a hazard associated with a loading or unloading location; and
updating the rule associated with a passenger type based on the information.

15. The method of claim 6, wherein the route solution is further based on reserved routes of a plurality of other customers.

16. The method of claim 6, further comprising:
determining that a route reserved for a second customer needs to be adjusted based on the route reserved for the first customer;
determining a routing change option for the second customer;
receiving a routing change selection;
reserving the routing change selection for the second customer; and
wherein determining that the route reserved for the second customer needs to be adjusted is based on the rule assigning a higher weighting factor to the first customer.

18. A system, comprising:
a processor; and
a memory including instructions that, when executed by the processor cause the system to:
receive a transportation request for a customer, the transportation request comprising a travel parameter of the customer having information that is indicative of a physical limitation of the customer;
determine a suitable vehicle configuration based on the travel parameter;
identify an available vehicle having a seat or space satisfying the suitable vehicle configuration;
transmit instructions to the available vehicle to reconfigure the seat or space to satisfy the suitable vehicle configuration;
receive a route selection from a set of potential routing solutions; and
transmit instructions to the available vehicle that are used to:
reserve the seat or space satisfying the suitable vehicle configuration; or
reconfigure the seat or space to satisfy the suitable vehicle configuration.

19. The system of claim 18, wherein the system is adapted to reconfigure the seat or space occurs automatically and can include collapsing or folding of the seat.

20. The system of claim 19, wherein the seat or space are reconfigured by adding or removing the seat.
